(19) United States
(12) Patent Application Publication
(10) Pub. No.: US 2019/0079353 A1
(43) Pub. Date: Mar. 14, 2019

(54) DISPLAY PANEL AND MANUFACTURING METHOD OF DISPLAY PANEL

(71) Applicant: HKC Corporation Limited, Shenzhen City (CN)

(72) Inventor: HUAILIANG HE, Shenzhen City (CN)

(21) Appl. No.: 16/163,178

(22) Filed: Oct. 17, 2018

Related U.S. Application Data
(63) Continuation of application No. PCT/CN2018/100597, filed on Aug. 15, 2018.

(30) Foreign Application Priority Data
Sep. 11, 2017 (CN) 2017108126815

(51) Int. Cl. G02F 1/1335

(52) U.S. Cl. CPC G02F 1/133617; G02F 1/133516; G02F 1/133528; G02F 1/133512; G02F 2202/28; G02F 2202/107; G02F 2202/108; G02F 2001/133519; G02F 2202/106

(57) ABSTRACT

A display panel and a manufacturing method of a display panel are provided. The display panel includes: a first substrate; a second substrate disposed in parallel and opposite to the first substrate; a liquid crystal layer disposed between the first substrate and the second substrate; a switch assembly formed on the first substrate; a color filter layer formed on the second substrate; a planarization layer disposed on the color filter layer. The planarization layer contains a material of quantum dots.

### FIELD OF THE DISCLOSURE

The disclosure relates to the field of display technology, and more particularly to a display panel and a manufacturing method of a display panel.

### BACKGROUND

Exemplary display devices usually are controlled based on active switches and have numerous advantages such as thin body, energy saving and radiation-free and thus have been widely used. The display devices primarily include liquid crystal display devices, OLED (Organic Light-Emitting Diode) display devices, QLED (Quantum Dot Light Emitting Diodes) display devices, plasma display devices and so on, and in terms of appearance structures, they may be flat-type display devices and/or curved-type display devices.

As to the liquid crystal display device, it includes two parts such as a liquid crystal panel and a backlight module. A working principle of the liquid crystal display device is disposing liquid crystal molecules between two parallel glass substrates and applying a driving voltage onto the two glass substrate to control rotation directions of the liquid crystal molecules to refract light rays from the backlight module and thereby produce an image.

With the continuous improvement of user's requirements for pictures, the traditional simple RGB (red, green and blue) color filter technique no longer meets the needs of users. Therefore, how to further improve display effect of a display panel has become an urgent problem to be solved by one skilled in the art.

### SUMMARY

An objective of the disclosure is to provide a display panel and a manufacturing method of a display panel, capable of improving display effect of the display panel.

In order to achieve the above objective, a display panel according to an embodiment of the disclosure includes: a first substrate; a second substrate, disposed in parallel and opposite to the first substrate; a liquid crystal layer, disposed between the first substrate and the second substrate; a switch assembly, formed on the first substrate; a color filter layer, formed on the second substrate; and a planarization layer, disposed on the color filter layer. The planarization layer contains a material of quantum dots. The color filter layer includes a hollowing area, the planarization layer includes an extension portion filled into the hollowing area, and the extension portion contains the material of quantum dots. The material of quantum dots is a material of red and green quantum dots.

In addition, another embodiment of the disclosure provides a display panel including: a first substrate; a second substrate, disposed in parallel and opposite to the first substrate; a liquid crystal layer, disposed between the first substrate and the second substrate; a switch assembly, formed on the first substrate; a color filter layer, formed on the second substrate; and a planarization layer, disposed on the color filter layer. The planarization layer contains a material of quantum dots.

In an embodiment of the disclosure, the color filter layer includes a hollowing area, the planarization layer includes an extension portion filled into the hollowing area, and the extension portion contains the material of quantum dots. In the embodiment, the hollowing area is the extension portion of the planarization layer and serves as a white filter of the color filter layer, so that the arrangement of the planarization layer may avoid losing good control on lithography and etching processes during the manufacturing process and can better ensure the shaping effect of the etching pattern. Herein, the planarization layer also serves as a carrier for the material of quantum dots so that the material of quantum dots can better cooperate with the color filter layer. In particular, the excited material of quantum dots converts a light source into multiple colors of lights (generally are red, green and blue lights) as output, cooperative with the color filter layer, it can improve the overall purity and brightness of the display panel and thereby improve the overall display effect of the display panel.

In an embodiment of the disclosure, the second substrate further is disposed with a color film conductive layer disposed opposite to the color filter layer, the second substrate even further is disposed with an upper polarizing layer disposed between the planarization layer and the color film conductive layer, the upper polarizing layer includes a transparent glue layer containing iodine molecules. In the embodiment, the second substrate is disposed with the color film conductive layer, the color film conductive layer is disposed at a side of the liquid crystal layer, and the planarization layer and the material of quantum dots are located between the color filter layer and the color film conductive layer. In addition, the upper polarizing layer is disposed between the planarization layer and the color film conductive layer, the upper polarizing layer includes a transparent glue layer containing iodine molecules, and correspondingly the display panel further is disposed with a lower polarizing layer. The upper polarizing layer and the lower polarizing layer are mutually orthogonal to each other and cooperatively work.

In an embodiment of the disclosure, the color filter layer includes a red filter, a green filter and a blue filter; the second substrate further is disposed with a blocking portion, and the blocking portion is located between adjacent two of the filters; the hollowing area is located between the red filter and the blue filter, the hollowing area and the planarization layer are in a same layer. In the embodiment, the hollowing area serves as a white filter of the color filter layer, the material of quantum dots may be applied to a color film substrate including red, green and blue filters, may be applied to a color film substrate including red, green, blue and white filters, and usually the material of quantum dots is applied to a red, green, blue and white color film process to achieve better effect, this is because the red, green, blue and white color film process would easily cause the problem of insufficient color saturation of display panel, and if the material of quantum dots is spin-coated on the planarization layer and a portion of the planarization layer doped with the material of quantum dots acts as the white filter, it can further improve the purity and brightness of the display panel and thereby improve the overall display effect of the display panel.

In an embodiment of the disclosure, the material of quantum dots is a material of red and green quantum dots. In the embodiment, the material of quantum dots may be a material of red and green quantum dots, and of course may be a material of other type and color quantum dots, and usually a backlight module including a blue backlight source is disposed corresponding to the material of red and green quantum dots so as to excite the red quantum dot and the green quantum dot to emit red and green lights with narrow bandwidth and thereby forming an output of red, green and blue lights, cooperative with the color filter layer, it can achieve the improvement of purity and brightness for the display panel. In addition, the material of quantum dots concretely may be cadmium selenide (CdSe), zinc sulfide (ZnS) or other compound.

In an embodiment, the display panel further comprises a backlight module disposed at an outer side of the first substrate, and the backlight module uses a blue light emitting diode as a backlight source; the first substrate is disposed with an array conductive layer, the switch assembly is located between the array conductive layer and the backlight module, and a lower polarizing layer is disposed between the backlight module and the array conductive layer. In the embodiment, the array conductive layer works cooperatively with the color film conductive layer, the lower polarizing layer works cooperatively with the upper polarizing layer. Moreover, the upper polarizing layer and the lower polarizing layer cooperatively work and are orthogonal to each other. The blue backlight source is for exciting the material of red and green quantum dots to emit light, so that the planarization layer emit red, green and blue lights and a portion thereof serving as the white filter is the main part of emitting the red, green and blue lights.

In an embodiment of the disclosure, the material of quantum dots is formed in the planarization layer by spin coating and doping. In the embodiment, the material of quantum dots is added in the planarization layer mainly by spin coating and doping, and of course may use other method to complete the addition of the material of quantum dots.

Finally, the disclosure further disclosure a manufacturing method of a display panel, including: providing a first substrate; providing a second substrate disposed opposite to the first substrate; forming a switch assembly on the first substrate; forming spacedly disposed blocking portions on the second substrate; forming a color filter layer on the blocking portions; forming a planarization layer containing a material of quantum dots on the color filter layer; and sequentially forming an upper polarizing layer and a color film conductive layer on the planarization layer. In the embodiment, the inventive point mainly is the improvement of the manufacturing process and structure of the color film substrate, with regard to the improvements of other parts of the display panel, they are not essential and the processes for manufacturing the other parts will not be described in detail in the manufacturing method.

In an embodiment of the disclosure, the color filter layer is formed with a hollowing area, the planarization layer includes an extension portion filled in the hollowing area, and the extension portion is filled with the material of quantum dots. In the embodiment, the hollowing area is the extension portion of the planarization layer and serves as a white filter of the color filter layer, the second substrate is disposed with the planarization layer opposite to the color filter layer, the arrangement of the planarization layer can avoid losing good control on lithography and etching processes during the manufacturing process and can better ensure the shaping effect of the etching pattern. Herein, the planarization layer also serves as a carrier for the material of quantum dots so that the material of quantum dots can better cooperate with the color filter layer. In particular, the excited material of quantum dots converts a light source into multiple colors of lights (generally are red, green and blue lights) as output, cooperative with the color filter layer, it can improve the overall purity and brightness of the display panel and thereby improve the overall display effect of the display panel.

In an embodiment of the disclosure, the upper polarizing layer as formed includes a transparent glue layer containing iodine molecules, the material of quantum dots is a material of red and green quantum dots, the material of red and green quantum dots is added into the planarization layer by spin coating and doping, and a backlight module of blue light source is disposed corresponding to such color film substrate. In the embodiment, the upper polarizing layer includes the transparent glue layer containing iodine molecules and is orthogonal to the lower polarizing layer (because the arrangement of the lower polarizing layer is not the main inventive point of the disclosure, and thus it is not mentioned in the manufacturing method) of the display panel. In addition, the material of quantum dot is added into the planarization layer mainly by spin coating and doping, and of course it may use other method to realize the addition of the material of quantum dots. Furthermore, the array conductive layer works cooperatively with the color film conductive layer, the lower polarizing layer works cooperatively with the upper polarizing layer. The upper polarizing layer and the lower polarizing layer cooperatively work and are orthogonal to each other. The blue backlight source is for exciting the material of red and green quantum dots to emit light, so that the planarization layer emit red, green and blue lights and a portion serving as the white filter is the main part of emitting the red, green and blue lights.

With regard to the display panel of the disclosure, since the second substrate (referred to as color film substrate) is added with the material of quantum dots, it may be a material of red and green quantum dots or a material of other type quantum dots, the red quantum dot, green quantum dot or blue quantum dot can emit lights as being excited by a suitable light such as backlight, under cooperative actions of structures such as the liquid crystal layer and the polarizing layers, it can effectively improve overall purity and brightness of the display panel and thereby improve the overall display effect of the display panel consequently.

### BRIEF DESCRIPTION OF THE DRAWINGS

Accompanying drawings are for providing further understanding of embodiments of the disclosure. The drawings form a part of the disclosure and are for illustrating the principle of the embodiments of the disclosure along with the literal description. Apparently, the drawings in the description below are merely some embodiments of the disclosure, a person skilled in the art can obtain other drawings according to these drawings without creative efforts. In the drawings:

FIG. 1 is a schematic view of a display panel according to an embodiment of the disclosure;

FIG. 2 is a flow chart of a manufacturing method of a display panel according to an embodiment of the disclosure;

FIG. 3 is a schematic view of a manufacturing process of a display panel according to an embodiment of the disclosure; and

FIG. 4 is a schematic view of a display apparatus according to an embodiment of the disclosure.

10, liquid crystal layer; 20, first substrate; 21: array conductive layer; 22: lower polarizing layer; 30, second substrate; 31, color filter layer; 32, material of quantum dots; 33, planarization layer; 34: color film conductive layer; 35: upper polarizing layer; 40, backlight module; 100, display panel; 200, control part; 300, display apparatus; 311, red filter; 312, green filter; 313, blue filter; 314, hollowing area.

### DETAILED DESCRIPTION OF EMBODIMENTS

The specific structural and functional details disclosed herein are only representative and are intended for describing exemplary embodiments of the disclosure. However, the disclosure can be embodied in many forms of substitution, and should not be interpreted as merely limited to the embodiments described herein.

In the description of the disclosure, terms such as “center”, “transverse”, “above”, “below”, “left”, “right”, “vertical”, “horizontal”, “top”, “bottom”, “inside”, “outside”, etc. for indicating orientations or positional relationships refer to orientations or positional relationships as shown in the drawings; the terms are for the purpose of illustrating the disclosure and simplifying the description rather than indicating or implying the device or element must have a certain orientation and be structured or operated by the certain orientation, and therefore cannot be regarded as limitation to the disclosure. Moreover, terms such as “first” and “second” are merely for the purpose of illustration and cannot be understood as indicating or implying the relative importance or implicitly indicating the number of the technical feature. Therefore, features defined by “first” and “second” can explicitly or implicitly include one or more the features. In the description of the disclosure, unless otherwise indicated, the meaning of “plural” is two or more than two. In addition, the term “include” and any variations thereof are meant to cover a non-exclusive inclusion.

In the description of the disclosure, it should be noted that, unless otherwise clearly stated and limited, terms “mounted”, “connected with” and “connected to” should be understood broadly, for instance, can be a fixed connection, a detachable connection or an integral connection; can be a mechanical connection, can also be an electrical connection; can be a direct connection, can also be an indirect connection by an intermediary, can be an internal communication of two elements. A person skilled in the art can understand concrete meanings of the terms in the disclosure as per specific circumstances.

The terms used herein are only for illustrating concrete embodiments rather than limiting the exemplary embodiments. Unless otherwise indicated in the content, singular forms “a” and “an” also include plural. Moreover, the terms “include” and/or “contain” define the existence of described features, integers, steps, operations, units and/or components, but do not exclude the existence or addition of one or more other features, integers, steps, operations, units, components and/or combinations thereof.

In the drawings, elements/components with similar structures are denoted by same reference numerals.

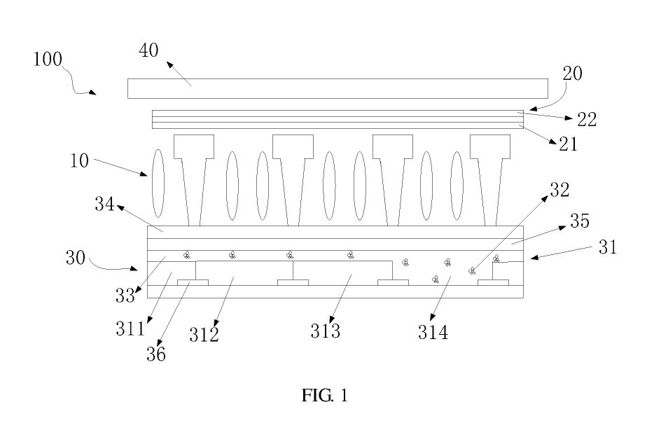

A display panel 100, a display apparatus 300 and a manufacturing method of a display panel in accordance with the disclosure will be further described below by embodiments with reference to FIG. 1 through FIG. 4.

FIG. 1 is a schematic view of a display panel according to an embodiment of the disclosure. As shown in FIG. 1, the display panel 100 provided by the embodiment of the disclosure includes:

a first substrate 20;

a second substrate 30, disposed in parallel and opposite to the first substrate 20;

a liquid crystal layer 10, disposed between the first substrate 20 and the second substrate 30;

a switch assembly, formed on the first substrate 20;

a color filter layer 31, formed on the second substrate 30;

a planarization layer 33, disposed on the color filter layer 31; and

wherein the planarization layer 33 has a material of quantum dots 32 contained therein.

As to the display panel of the disclosure, because a color filter substrate (with the color filter layer and the planarization layer) is added with the material of quantum dots which may be a material of red and green quantum dots or a material of other type quantum dots, and red quantum dots, green quantum dots or blue quantum dots in the material of quantum dots are excited to emit lights by a suitable light such as backlight, under cooperative actions of structures such as the liquid crystal layer and the polarizing layers, it can effectively improve the overall purity and brightness of the display panel and thereby improve the overall display effect of the display panel.

In an exemplary embodiment, the color filter layer 31 includes a hollowing area 314. The hollowing area 314 has an extension portion of the planarization layer 33 disposed therein. The extension portion contains a material of quantum dots 32. In the embodiment, the hollowing area has the extension portion of the planarization portion disposed therein and acts as a white filter of the color filter layer, the second substrate is disposed with the planarization layer opposite to the color filter layer, and the arrangement of the planarization layer may avoid losing good control on lithography and etching processes during the manufacturing process and can better ensure the shaping effect of the etching pattern. Herein, the planarization layer serves as a carrier for the material of quantum dots so that the material of quantum dots can better cooperate with the color filter layer. In particular, the excited material of quantum dots converts a light source into multiple colors of lights (generally are red, green and blue lights) for output, cooperative with the color filter layer, it can improve the overall purity and brightness of the display panel and thereby improve the overall display effect of the display panel.

In an exemplary embodiment, the second substrate 30 is disposed with a color film conductive layer 34 (generally referred to as a conductive layer on a color film substrate) disposed opposite to the color filter layer 31. The second substrate 30 further is disposed with an upper polarizing layer 35 located between the planarization layer 33 and the color film conductive layer 34. The upper polarizing layer 35 includes a transparent glue layer containing Iodine molecules (not shown in the drawings). In the illustrated embodiment, the second substrate is disposed with the color film conductive layer located at a side of the liquid crystal layer, and the planarization layer and the material of quantum dots are disposed between the color filter layer and the color film conductive layer; in addition, the planarization layer and the color film conductive layer have the upper polarizing layer disposed therebetween, the upper polarizing layer includes a transparent glue layer containing iodine molecules, and correspondingly the display panel further is disposed with a lower polarizing layer. The upper polarizing layer and the lower polarizing layer are orthogonal to each other and cooperatively work.

In an exemplary embodiment, the color filter layer 31 includes a red filter 311, a green filter 312 and a blue filter 313. The second substrate 30 further is disposed with blocking portions 36 (e.g., black matrix in contact with the extension portion of the planarization layer 33), and the blocking portions 36 each are disposed between adjacent two of the filters. The hollowing area 314 is disposed between the red filter 311 and the blue filter 313, and located in a same layer with the planarization layer 33. In the embodiment, the material of quantum dots may be applied to a color film substrate including red, green and blue filters, or applied to a color film substrate including red, green, blue and white filters, but generally the material of quantum dots can achieve better effect when being applied to a red, green, blue and white color film process, this is because the red, green, blue and white color film process easily causes the problem of insufficient color saturation of display panel, and if the material of quantum dots is spin-coated on the planarization layer and a portion of the planarization layer doped with the material of quantum dots serves as the white filter, it can improve the purity and brightness of the display panel by the material of quantum dots and thereby improve the overall display effect of the display panel.

In an exemplary embodiment, the material of quantum dots 32 is a material of red and green quantum dots. In the embodiment, the material of quantum dots may be a material of red and green quantum dots and of course may be a material of other type and color quantum dots. Usually, corresponding to the material of red and green quantum dots, a backlight module including a blue backlight source is disposed so as to excite the red quantum dot and the green quantum dot to emit red and green lights with narrow bandwidth and thereby form an output of red, green and blue lights, cooperative with the color filter layer, the improvements of purity and brightness of the display panel consequently can be realized. In addition, the material of quantum dots concretely may be cadmium selenide (CdSe), zinc sulfide (ZnS) or other compound.

In an exemplary embodiment, the display panel 100 further includes a backlight module 40 disposed at the outer side of the first substrate 20. The backlight module 40 uses a blue light emitting diode as a backlight source. The first substrate 20 is disposed with an array conductive layer 21 (generally referred to as conductive layer on an array substrate), and the switch assembly is disposed between the array conductive layer 21 and the backlight module 40. The backlight module 40 and the array conductive layer 21 have a lower polarizing layer 22 disposed therebetween. In the embodiment, the array conductive layer works cooperative with the color film conductive layer, and the lower polarizing layer works cooperatively with the upper polarizing layer. The upper polarizing layer and the lower polarizing layer cooperatively work and are orthogonal to each other. The blue backlight source is used for exciting the material of red and green quantum dots to emit lights, so that the planarization layer can emit red, green and blue lights and the portion as the white filter is the main portion of emitting the red, green and blue lights.

In an exemplary embodiment, the material of quantum dots 32 is formed in the planarization layer 33 by spin coating and doping. In the embodiment, the material of quantum dots 32 is added into the planarization layer mainly by spin coating and doping, and of course the addition of the material of quantum dots may be completed by other manner.

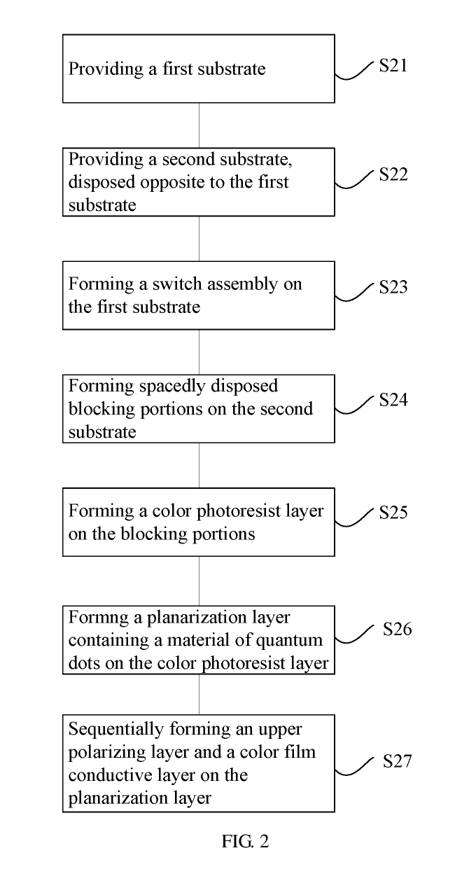

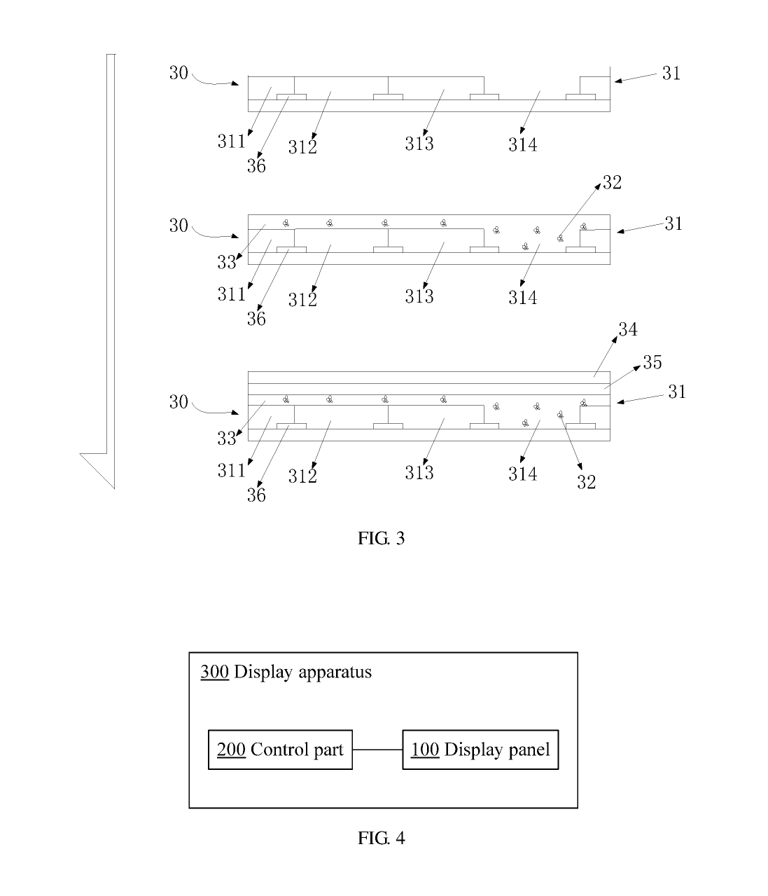

FIG. 2 is a flow chart of a manufacturing method of a display panel according to an embodiment of the disclosure, and FIG. 3 is a schematic view of a manufacturing process of the display panel according to an embodiment of the disclosure. Referring to FIG. 2 and FIG. 3, in combination with FIG. 1, it can be found that, the disclosure further provides a manufacturing method of a display panel, including the following steps.

S21: providing a first substrate 20;

S22: providing a second substrate 30, disposed opposite to the first substrate 20;

S23: forming a switch assembly on the first substrate 20;

S24: forming spacedly disposed blocking portions 36 on the second substrate 30;

S25: forming a color filter layer 31 on the blocking portions 36;

S26: forming a planarization layer 33 containing a material of quantum dots on the color filter layer 31;

S27: sequentially forming an upper polarizing layer 35 and a color film conductive layer 34 on the planarization layer 33.

In an exemplary embodiment, the color filter layer 31 is formed with a hollowing area, the planarization layer 33 includes an extension portion filled into the hollowing area, and the extension portion is contained with a material of quantum dots. In the embodiment, the hollowing area is the extension portion of the planarization layer and serves as a white filter of the color filter layer, the second substrate is disposed with the planarization layer opposite to the color filter layer, the arrangement of the planarization layer may avoid losing good control on lithography and etching processes during the manufacturing process and can better ensure the shaping effect of the etching pattern. Herein, the planarization layer serves as a carrier for the material of quantum dots so that the material of quantum dots can better cooperate with the color filter layer. In particular, the material of quantum dots converts a light source into multiple colors of lights (generally are red, green and blue lights) as output, cooperative with the color filter layer, it can improve the overall purity and brightness of the display panel and thereby improve the overall display effect of the display panel.

In the manufacturing method of a display panel of the disclosure, main improvement points are the improvements of the color film substrate and related structures, and for the color film substrate (with color filter layer and planarization layer), because the color film substrate is added with the material of quantum dots, and the material of quantum dots may be a material of red and green quantum dots or a material of other type quantum dots. A red quantum dot, a green quantum dot or a blue quantum dot in the material of quantum dots can be excited by a suitable light e.g., backlight to emit lights, under the cooperative actions of structures such as the liquid crystal layer and the polarizing layers, it can effectively improve the overall purity and brightness of the display panel and thereby improve the overall display effect of the display panel.

In the illustrated embodiment, the disclosure mainly focuses on the improvements of the manufacturing process as well as structure of the color film substrate, the improvements of the other parts of the display panel are not essential, and therefore the processes for manufacturing the other parts will not be described in detail in the manufacturing method.

In an exemplary embodiment, the upper polarizing layer 34 as formed includes a transparent glue layer containing iodine molecules. The material of quantum dots is a material of red and green quantum dots. The material of red and green quantum dots 32 is added into the planarization layer 33 by spin coating and doping. In the embodiment, the upper polarizing layer includes the transparent glue layer containing iodine molecules and is orthogonal to the lower polarizing layer (because the arrangement of the lower polarizing layer is not the main inventive point of the disclosure, and thus it is not mentioned in the manufacturing method) of the display panel. In addition, the material of quantum dots is added into the planarization layer mainly by spin coating and doping, and of course it may use other method to complete the addition of the material of quantum dots.

In an exemplary embodiment, corresponding to the color film substrate, a backlight module 40 including a blue light source is disposed. In the embodiment, the array conductive layer works cooperatively with the color film conductive layer, the lower polarizing layer works cooperatively with the upper polarizing layer. The upper polarizing layer and the lower polarizing layer work cooperatively and are mutually orthogonal to each other. The blue backlight source is used for exciting the material of red and green quantum dots to emit lights, so that the planarization layer can emit red, green and blue lights, and the portion thereof as the white filter is the main part of emitting the red, green and blue lights.

In the above embodiments, the display panel may be a liquid crystal display panel, an OLED (Organic Light-Emitting Diode) panel, a QLED (Quantum Dot Light Emitting Diodes) panel, a plasma panel, a flat-type panel, a curved-type panel and so on. For the liquid crystal display panel, the liquid crystal layer is filled with liquid crystal molecules, and display grayscales of the display panel are controlled by controlling rotation angles of the liquid crystal molecules.

FIG. 4 is a schematic view of a display apparatus according to an embodiment of the disclosure. Referring to FIG. 4, the embodiment discloses a display apparatus 300. The display apparatus 300 includes a control part 200 and the above mentioned display panel 100. The above description uses the display panel as an example to describe in detail, it should be noted that, the above description for the structure of the display panel also is applicable to the display apparatus of the illustrated embodiment of the disclosure. When the display apparatus of the illustrated embodiment of the disclosure is a liquid crystal display device, the liquid crystal display device includes a backlight module, and the backlight module may be used as a light source and for supplying a light source with sufficient brightness and uniform distribution. The backlight module in the illustrated embodiment may be front light type or backlight type, and it should be noted that the backlight module of the illustrated embodiment is not limited to these.

The foregoing contents are detailed description of the disclosure in conjunction with specific embodiments, and it is not to be determined that the specific embodiments of the disclosure are limited to the description. For the person skilled in the art of the disclosure, without departing from the concept of the disclosure, simple deductions or substitutions can be made and should be included in the protection scope of the application.

What is claimed is:

1. A display panel comprising:
a first substrate;
a second substrate, disposed in parallel and opposite to the first substrate;
a liquid crystal layer, disposed between the first substrate and the second substrate;
a switch assembly, formed on the first substrate;
a color filter layer, formed on the second substrate;
a planarization layer, disposed on the color filter layer;
wherein the planarization layer contains a material of quantum dots;
wherein the color filter layer comprises a hollowing area, the planarization layer comprises an extension portion filled into the hollowing area, and the extension portion contains the material of quantum dots.
wherein the material of quantum dots is a material of red and green quantum dots.

2. A display panel comprising:
a first substrate;
a second substrate, disposed in parallel and opposite to the first substrate;
a liquid crystal layer, disposed between the first substrate and the second substrate;
a switch assembly, formed on the first substrate;
a color filter layer, formed on the second substrate;
a planarization layer, disposed on the color filter layer;
wherein the planarization layer contains a material of quantum dots.

3. The display panel according to claim 2, wherein the color filter layer comprises a hollowing area, the planarization layer comprises an extension portion filled into the hollowing area, and the extension portion contains the material of quantum dots.

4. The display panel according to claim 3, wherein the hollowing area acts as a white filter of the color filter layer.

5. The display panel according to claim 3, wherein the second substrate further is disposed with:
a color film conductive layer, disposed opposite to the color filter layer; and
an upper polarizing layer, disposed between the planarization layer and the color film conductive layer, wherein the upper polarizing layer comprises a transparent glue layer containing iodine molecules.

6. The display panel according to claim 5, wherein the color film conductive layer is disposed at a side of the liquid crystal layer; the planarization layer and the material of quantum dots are located between the color filter layer and the color film conductive layer.

7. The display panel according to claim 3, wherein the color filter layer comprises a red filter, a green filter and a blue filter;
the second substrate further is disposed with a blocking portion, and the blocking portion is located between adjacent two of the filters;
the hollowing area is located between the red filter and the blue filter, the hollowing area and the planarization layer are in a same layer.

8. The display panel according to claim 2, wherein the material of quantum dots is a material of red and green quantum dots.

9. The display panel according to claim 2, wherein the material of quantum dots comprises cadmium selenide.

10. The display panel according to claim 2, wherein the material of quantum dots comprises zinc sulfide.

11. The display panel according to claim 2, wherein the display panel further comprises a backlight module disposed at an outer side of the first substrate, and the backlight module uses a blue light emitting diode as a backlight source;
the first substrate is disposed with an array conductive layer, the switch assembly is located between the array conductive layer and the backlight module, and a lower polarizing layer is disposed between the backlight module and the array conductive layer.

12. The display panel according to claim 11, wherein the lower polarizing layer and the upper polarizing layer are mutually orthogonal to each other.

13. The display panel according to claim 3, wherein the material of quantum dots is formed in the planarization layer by spin coating and doping.

14. A manufacturing method of a display panel, comprising:
providing a first substrate;
providing a second substrate disposed opposite to the first substrate;
forming a switch assembly on the first substrate;
forming spacedly disposed blocking portions on the second substrate;
forming a color filter layer on the blocking portions;
forming a planarization layer containing a material of quantum dots on the color filter layer;
sequentially forming an upper polarizing layer and a color film conductive layer on the planarization layer.

15. The manufacturing method of a display panel according to claim 14, wherein the color filter layer is formed with a hollowing area, the planarization layer comprises an extension portion filled in the hollowing area, and the extension portion is filled with the material of quantum dots.

16. The manufacturing method of a display panel according to claim 15, wherein the color filter layer comprises a red filter, a green filter and a blue filter;
the blocking portions each are located between adjacent two of the filters;
the hollowing area is located between the red filter and the blue filter, and the hollowing area and the planarization layer are in the same layer.

17. The manufacturing method of a display panel according to claim 14, wherein the first substrate is disposed with an array conductive layer, and the switch assembly is located between the array conductive layer and a backlight module.

18. The manufacturing method of a display panel according to claim 17, wherein a lower polarizing layer is disposed between the backlight module and the array conductive layer, and the lower polarizing layer and the upper polarizing layer are mutually orthogonal to each other.

19. The manufacturing method of a display panel according to claim 14, wherein the upper polarizing layer as formed comprises a transparent glue layer containing iodine molecules;
the material of quantum dots is a material of red and green quantum dots, and the material of red and green quantum dots is added into the planarization layer by spin coating and doping;
a backlight module of blue light source is disposed corresponding to a color film substrate including the color filter layer and the planarization layer.

20. The manufacturing method of a display panel according to claim 14, wherein the material of quantum dots comprises cadmium selenide or zinc sulfide.
